(19) United States
(12) Patent Application Publication
(10) Pub. No.: US 2006/0146731 A1
(43) Pub. Date: Jul. 6, 2006

(54) Distributed network discovery

(75) Inventors: Timothy Adrian Lewis, Bristol (GB); Gary Clemo, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/261,514

(22) Filed: Oct. 31, 2005

(30) Foreign Application Priority Data
Jan. 6, 2005 (GB) 0500185.4

(51) Int. Cl. H04L 12/28

(52) U.S. Cl. 370/254

(57) ABSTRACT

The invention provides a method of sharing the searching burden for discovering available services in a wireless network. Terminals within the network carry out searches of part of the available spectrum and communicate information between each other to establish a database of collective information.

The present invention relates to a network service information discovery method and a communication device adapted to perform such a method.

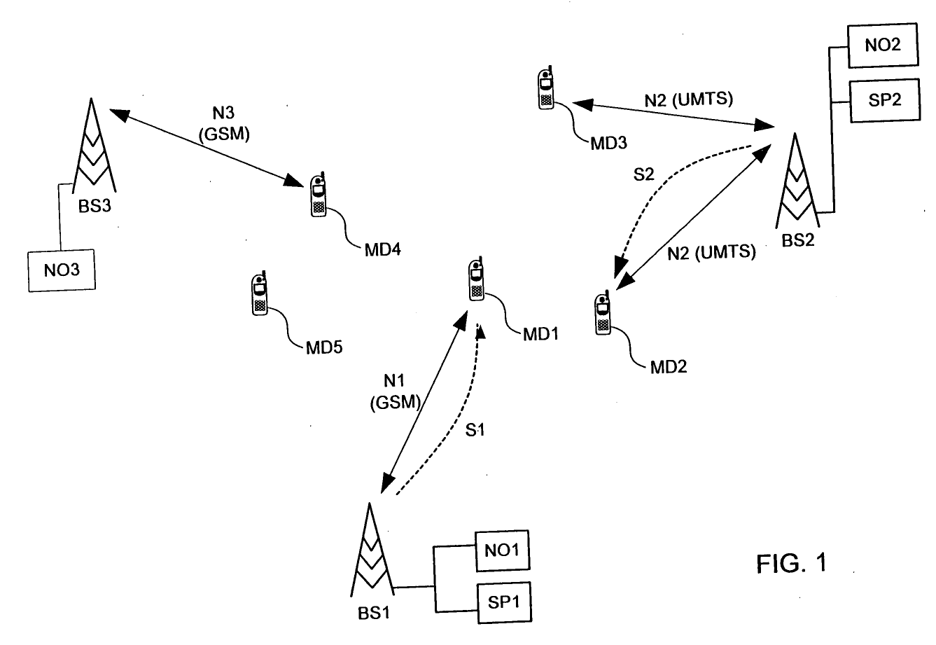

FIG. 1 of the accompanying drawings is a schematic diagram illustrating the interaction between a plurality of mobile devices MD1 to MD5 with a plurality of network operators NO1 to NO3 and service providers SP1 to SP2. In FIG. 1, mobile device MD1 is connected to and communicating over a network N1 provided by network operator NO1. Mobile device MD1 is within communication range of a base station BS1 and the network operator NO1 is using base station BS1 to communicate with mobile device MD1. Similarly, mobile devices MD2 and MD3 are connected to and communicating over a network N2 provided by a network operator NO2 via a base station BS2. Mobile device MD4 is connected to and communicating over a network N3 provided by network operator NO3 via a base station BS3.

Also illustrated in FIG. 1 are two service providers SP1 and SP2. Mobile device MD1 is using a service S1 provided by the service provider SP1 over the network N1, while the mobile device MD2 is using a service S2 provided by the service provider SP2 over the network N2. The service provider SP1 may or may not be the same commercial entity as the network operator NO1, and similarly for the service provider SP2 and the network operator NO2. Conventionally it has been the case that a particular network operator would also be the service provider for that network. However, it is envisaged that in the future it will be more common that a user of a mobile device will be able to choose a service provider irrespective of the network operator that is operating the network to which the mobile device is connected. The identity of the service provider is usually of little importance to the user, the type and quality of the service itself usually being of more relevance.

In this example, the network operators NO1 and NO2 are providing a different type of network. Network N1 is a GSM network while network N2 is a UMTS network.

Network N3 is of the same type as network N1 (GSM), but is provided by a different network operator and accordingly has a different configuration (e.g. operating frequency range) to that of the network N1.

The most common type of mobile device available is a single-mode mobile device which is adapted and configured to communicate over a single type of network. For example, a single-mode GSM mobile device is not able to connect to a UMTS network.

Second generation mobile phones, such as those that operate according to the GSM system, conventionally detect the presence of available networks by scanning known portions of the radio spectrum. These portions of spectrum are static and are set out on a regional basis by regulators. Since a GSM mobile device operates according to the GSM standard, it will know how to identify a GSM bearer present within the spectrum range scanned. For example, if the mobile device MD5 is a single-mode GSM mobile device then it would perform a network discovery procedure by scanning the GSM operating frequency range to determine that networks N1 and N3 are available, following which it could connect to either of these networks.

Multi-mode mobile devices are capable of communicating over any one of a number of network types. For example, one type of multi-mode mobile device MD is capable of communicating both over a GSM network and a UMTS network. The task of detecting available networks is therefore harder than for a single-mode mobile device.

A re-configurable mobile device takes the multi-mode concept further, and such a mobile device is able to modify its radio, protocol stack, system and application software to operate on a limitless number of networks. Therefore, if a re-configurable mobile device is seeking available networks, it will conceivably need to search for all network technologies. Detecting the presence of alternative modes in a given location is a non-trivial task. The re-configurable mobile device will be required to suspend current activity whilst it monitors the air interface, at a range of frequencies, for a range of modulation schemes, before returning to its current mode. If the frequency range scanned by the mobile device is large then the time taken to perform the scanning operation could result in the mobile device becoming unavailable for extended periods, which has clear implications for the user. This situation is greatly exacerbated if the mobile device is “in call”, in the traditional sense, or otherwise maintaining a communication session. The scanning process also presents a large drain on limited battery resources.

Spectrum for radio communications systems is currently allocated in a static manner. Portions of spectrum are allocated periodically for emerging systems and each system keeps within its spectrum allocation. However, there is pressure to change the way in which spectrum is allocated since operators are at present forced to purchase spectrum before knowing how much of it they actually require. As mobile device technology becomes more flexible and re-configurable, there are proposals to make the spectrum allocation process more flexible too, with the dynamic allocation of spectrum on a temporal or regional basis. This in turn will make the process of network detection and monitoring still harder, since a mobile device will need to scan large portions of spectrum (for example 400 MHz to 60 GHz) without knowing what type of network technology will be found at any particular frequency. For example, a terminal must initially select a frequency or frequency range and a network type and then detect any signal present and decode that using the correct modulation scheme. It must then analyse the received signal to identify if that includes any valid data. If no valid data is detected, it must assume there is no valid service there and continue searching. Consequently, the task must be repeated for different frequencies, modulation types, channel, network type etc. The time to scan will accordingly be very large, service discontinuities are likely and the drain on battery life will be significant.

It is therefore desirable to provide an alternative method for discovery of network and service information.

References to network service information in this document relate to information relating to the various parameters, e.g. frequency, technology, modulation type, channels etc., which define the various services that a mobile terminal may connect to. Similarly, the term network service spectrum relates to the range of available network services. Thus scanning the network service spectrum might involve not only searching a given frequency range but also searching for different technologies, channels etc.

According to the present invention there is provided a collaborative discovery method for discovering available network services at a communication terminal, the method comprising: receiving network service spectrum information; updating stored network service spectrum information using said received network service spectrum information; selecting a portion of the network service spectrum to be searched based upon the stored network service spectrum information; and searching said selected portion of the network service spectrum.

This allows a terminal which has newly joined a local network or currently part of a local network to communicate with its neighbours to obtain information on the available services in some or all of the spectrum, without having to extensively search the complete potential spectrum. In this way, the terminal may immediately be able to locate a suitable service from the information without searching. However, the present invention allows the terminal to search for other services in a more focussed manner by allowing the search to be conducted only in the parts of the network service spectrum which it does not have any information on. Traditionally, a terminal would have no information initially. However, by utilising the available information from its neighbours, it can reduce the searching space that it must consider and hence reduce the searching task.

This collaboration allows a group of terminals in a local network to work together to identify and maintain up to date information on the available services whilst sharing the searching burden. This is achieved by initially sharing the information each obtains to allow each terminal to make an educated selection of the network service spectrum to be searched rather than searching all or large portions of the spectrum and effectively repeating the searching task of others.

The method may further comprise updating said stored network service spectrum information using said network service spectrum information located during said searching. This allows information from other terminals as well as that discovered during searches to be used to maintain the stored database of information.

Preferably, the discovered information, i.e. the network service information located during said searching, is broadcast. This allows other devices to use the results of the search to update their own stored information. The discovered information which is broadcast includes information identifying those network services which are located within the selected and searched network service spectrum. This provides other terminals with information on available services/networks. Thus they can apply the invention to optimise their searching strategy.

Advantageously, broadcast information may include details of the selected portion of the network service spectrum which was searched. This means that even if services are not located in the searched portion of the spectrum, other terminals know that searching there is pointless and thus saves needless searching.

Preferably, broadcast information includes a unique terminal identifier, identifying the sending terminal. This allows other terminals to identify the source of data and also to know how many different terminals are broadcasting data which it receives. This is useful in determining the size of the group of terminals carrying out searching.

The stored network service spectrum information may be broadcast in response to a request received from another terminal or at predetermined intervals or in response to an internal trigger within the terminal.

The portion of the network service spectrum to be searched is preferably selected from the portions of the stored network service spectrum on which no valid information is stored. The store may have no information or have information which has ceased to be valid, for example because it is too old. Thus, searches are carried out on those portions of the spectrum on which no valid information is held in order to fill in the gaps in information between the portions of the spectrum which have been searched and the information is still valid.

Preferably, information is determined not to be valid if it is older than a predetermined age and/or collected at a location more than a predetermined distance from the current location of the terminal. Other factors may be used to determine data to be invalid. For example if an attempt to connect to a service has failed, the data identifying that service may be deemed to be invalid.

The portion of the network service spectrum to be searched may be randomly selected. This may be because of lack of information in the stored database or simply to ensure that terminals with the same information do not search the same portion of the spectrum. By randomly selecting the portion to search, there is a statistically high probability that a significant portion of the unsearched spectrum will be searched.

The size of the selected portion of the network service spectrum to be searched can be determined based upon the number of neighbouring terminals; the capability of the terminal to carry out searching, relative to neighbouring terminals; capacity of the secondary network over which the network service spectrum information is broadcast and/or received; or the terminal's remaining power reserve. As indicated above, the number of neighbouring terminals can be determined by identifying each unique terminal which broadcast information is received from based upon a unique identification broadcast by the terminals.

The searching step may by repeated if some or all of the stored network service spectrum information is older than a predetermined age; some or all of the stored network service spectrum information was collected at a location more than a predetermined distance from the current location of the terminal; the terminal requires a network service which is not included in the stored network service spectrum information or if the data stored is determined to be no longer valid such as suggested above.

The present invention also provides a collaborative discovery method for discovering available network services, the method comprising: searching a randomly selected portion of the network service spectrum and storing discovered network service spectrum information; broadcasting information concerning the network service spectrum searched; receiving network service spectrum information; and updating stored network service spectrum information using said received network service spectrum information.

This arrangement allows a terminal newly entering a location or newly communicating (e.g. switched on) to carry out an initial search without prior information and to pass that on to other terminals. This can be done before connecting to a primary network. Even if no service is located initially, the terminal is still contributing to the common knowledge of the terminal neighbourhood. Having provided its information and joined the local network, it may then be able to obtain information on available services without having to slavishly search the entire network service spectrum.

The present invention further provides a collaborative discovery method for discovering network services to a plurality of communication terminals, the method comprising: each terminal receiving network. service spectrum information from one or more of the other of said plurality of terminals; maintaining stored network service spectrum information at one or more of said plurality of terminals and updating said network service spectrum information based upon said received network service spectrum information; one or more of said plurality of terminals periodically selecting a portion of the network service spectrum to be searched based upon the stored network service spectrum information and searching said selected portion of the network service spectrum; and each terminal periodically broadcasting said stored network service spectrum information.

A communication terminal in accordance with the present invention, for discovering available network services, comprises: a receiver arranged to receive network service spectrum information; network service spectrum information storage; a storage manager arranged to store network service spectrum information in said storage and to update said network service spectrum information using said received network service spectrum information; a selector arranged to determine a portion of the network service spectrum to be searched based upon the stored network service spectrum information; and a spectrum scanner for searching said portion of the network service spectrum.

The network service spectrum information may comprise network configuration data relating to a network that enables a device to be configured to communicate over that network. The network configuration data may comprise one or more radio physical layer characteristics of the network concerned, for example the operating frequency range of the network concerned.

The network service spectrum information may comprise service configuration data relating to a service that enables a device to use that service. The network service spectrum information may comprise network performance data relating to the performance of a network. The network performance data may comprise a Quality of Service indication for the network concerned. The network service spectrum information may comprise information identifying a network and/or service. The network service spectrum information may comprise costing information relating to a network and/or service.

A plurality of different network types may be available and terminals may be capable of communicating over more than one network type. One of the network types may be a GSM network.

The terminals may use a primary network channel to communicate as well as a secondary channel, different to the primary communication channel, for transmitting the network service information between terminals. The secondary communications channel may be a Bluetooth™ communications channel. The primary communications channel may be a GSM channel.

The network service spectrum information may be transmitted from a device following a request received from another device. The request may be broadcast. The network service spectrum information may be broadcast periodically by a device for receipt by any other device within range of the broadcast.

The network service spectrum information may be generated by a device that has connected to the network and/or used the service to which the information relates. The network service information may comprise time stamp data indicating the time when it was generated or updated by a device and the validity of the information may be dependent upon the time stamp data. The information may be deemed void after a predetermined length of time from the time indicated by the time stamp data.

The network service spectrum information may comprise location stamp data indicating the location at which it was generated by a device and the validity of the information may be dependent upon the location stamp data. The information may be deemed void a predetermined distance from the location indicated by the location stamp data.

A service may be provided over a network, or it may be provided direct to a mobile device without using an established network. The invention may be used for configuring a terminal for connection to a network using network configuration data obtained using the collaborative discovery method.

The communication device may be reconfigured based on network performance data of the network service spectrum information. The network performance data may relate to the performance of the first network. The network performance data may relate to the performance of the second network.

The present invention can be implemented either in hardware or on software in a general purpose processor or processing apparatus. Further, the present invention can be implemented in a combination of hardware and software. The present invention can also be implemented by a single processing apparatus or a distributed network of processing apparatuses.

Since the present invention can be implemented by software, the present invention encompasses computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal.

The present invention will now be described in more by detail by reference to the drawings in which:

FIG. 1 is an illustrative diagram showing typical network and service connections established in a conventional manner;

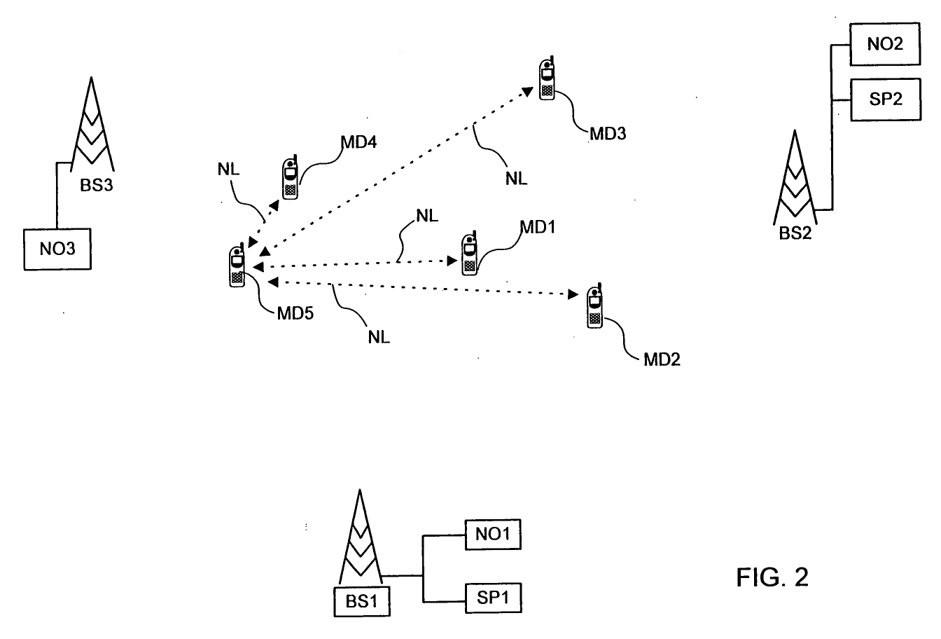

FIG. 2 is an illustrative diagram showing the distribution of network service information in a collaborative discovery method embodying the present invention;

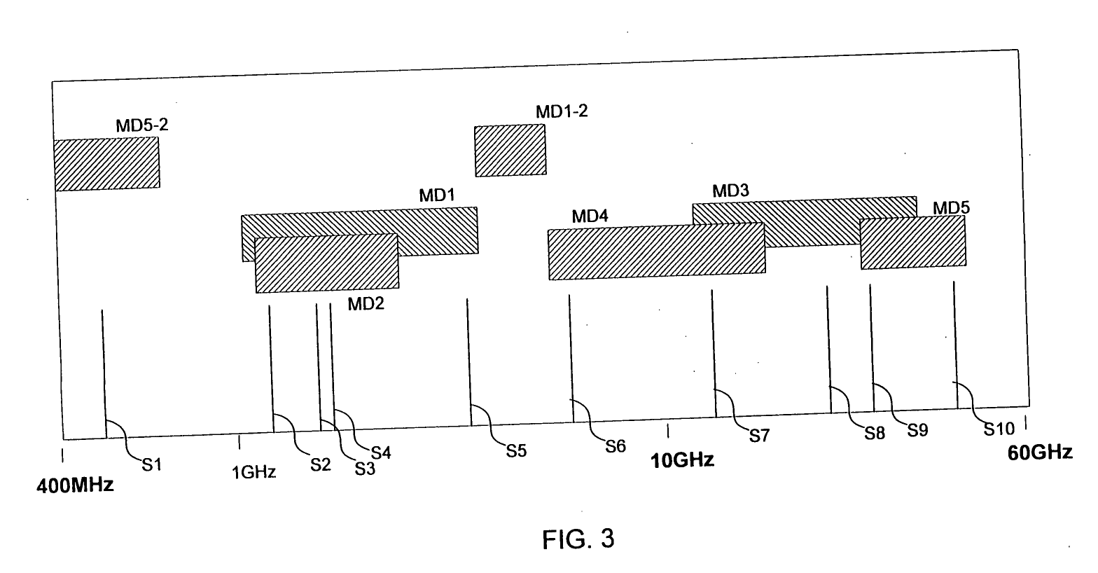

FIG. 3 is an illustrative diagram showing a spectrum and how portions are searched based upon previous search information;

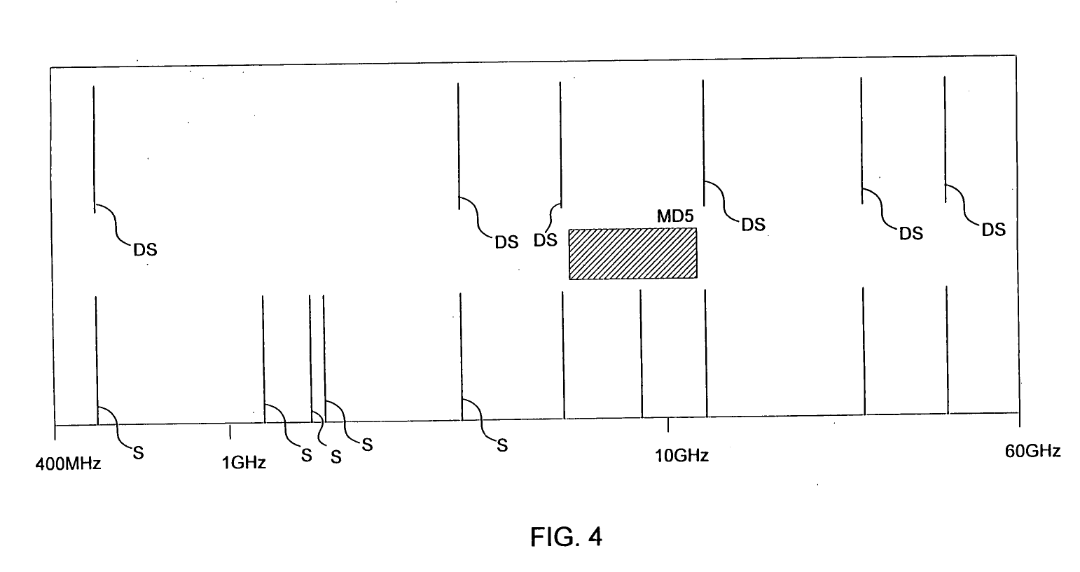

FIG. 4 is an illustrative diagram showing a spectrum and how portions are searched based upon known services; and

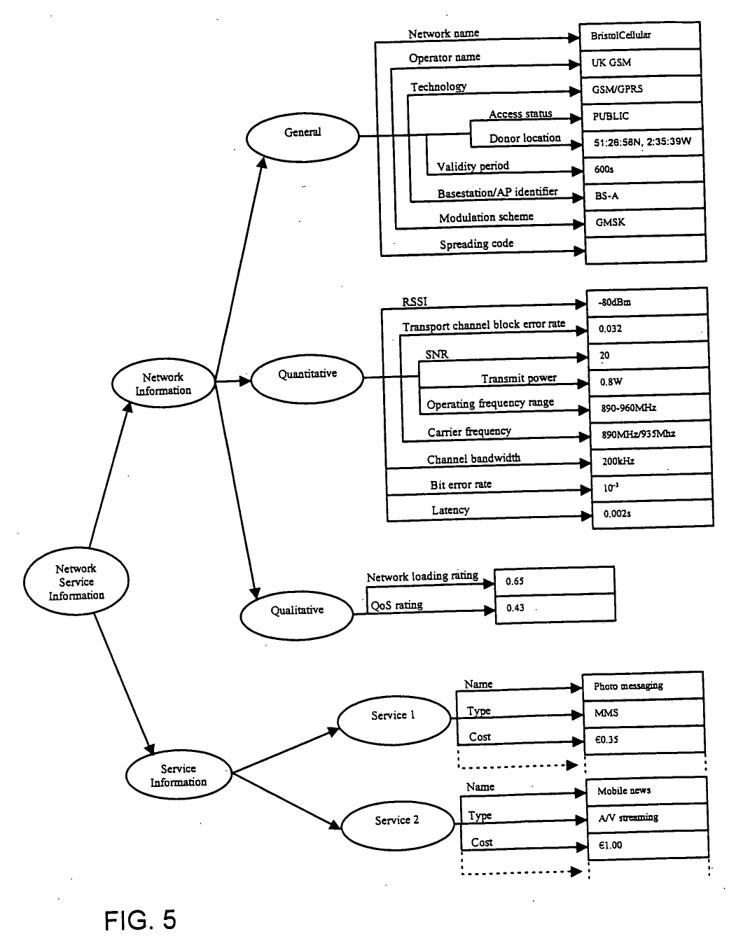

FIG. 5 shows the type of network service information which the present invention may be used to identify.

In the example described above, with reference to FIG. 1, the mobile device MD5 which wishes to newly connect to a service or wishes to find a different service, would discover the existence of network N1 by performing a conventional spectrum-scanning method prior to the establishment of communication over the network N1. As will be described below, in an embodiment of the present invention an alternative approach is taken which avoids the need for every terminal to scan the entire potential service spectrum.

FIG. 2 shows a similar layout to that of FIG. 1. FIG. 2 is an illustrative diagram showing a communications system having the same basic elements as the communications system shown in FIG. 1 but in which the elements are adapted to perform a collaborative discovery method embodying the present invention. The network/service connections have been omitted for clarity. The terminals MD1 to MD4 could still be connected to the networks using the services shown in FIG. 1. The important point is that each of the terminals in MD1 to MD4 has existing knowledge of some of all of the networks and services which are available to it.

When a new terminal MD5 wishes to find a new service or network to connect to it, it initially needs to establish the details of that network e.g. frequency, technology etc. The terminal may already be connected to one network and wish to find an alternative network or the terminal may simply wish to connect to a new network, for example having just been switched on. Initially, the terminal may not have communicated with any other terminals in the local area and so has no knowledge of the available networks. In this situation, the terminal can randomly choose a portion of the network service spectrum and explore which services are available within it. If the search yields a useful service then the terminal can determine whether or not it wishes to connect to that service. Having conducted the search, the terminal now has useful information about the availability of services within the portion of the spectrum it has searched. This information can then be made available to other terminals to update their knowledge of the services available.

Alternatively, the terminal can initially communicate with other terminals within range to obtain information which those devices hold about the services available. The information would preferably be obtained form the local terminals by communicating using a short range wireless link such as Bluetooth™, wireless LAN, infrared etc. However, the information may be transmitted indirectly via a connection to an existing network.

Having established some information. about the available networks and services, as a result of its own searching and/or from information obtained from other devices, the terminal can determine which, if any, services to connect to.

Once the terminal has obtained information from the other terminals in the local network, it can start to develop its own database of the service spectrum in the area. FIG. 3 shows an example of the information that terminal MD5 may collect. FIG. 3 shows a representation of a spectrum having a number of services S1-S10 available within the spectrum. The services may use any kind of technology such as TDMA, spread spectrum, etc. and the lines in FIG. 3 indicating a service are simply schematic.

As is shown in FIG. 2, the terminal MD5 receives information about the portions of the spectrum which each of the terminals are searched using the local network link N1. In the example of FIG. 3, the search carried out by terminal MD1 has located four services S2-S5. The information received from MD2 has located three services S2-S4. However, the information provided by terminal MD2 is encompassed by the spectrum searched by MD1. Whilst this might appear to make the information provided from terminal MD2 redundant, each of the terminals may have searched for a different type of service for example the terminal MD2 may be searching for UMTS and GSM services whilst the terminal MD1 is only searching for GSM services. Thus in some instances, this duplication of searching the same part of the frequency spectrum might not be fruitless. Furthermore, the terminals MD1 and MD2 are in different locations and so one may be more relevant than the other.

Again the information provided from terminals MD3 and MD4 provides further potential services S6-S9, to which the terminal MD5 may wish to connect. In addition to the information received by the terminal MD5, it may have carried out its own search of a randomly selected portion of the spectrum, as indicated above. In the example given, MD5 located services S9 and S10

In the example shown in FIG. 3, after the terminals MD1 to MD5 have carried out their searches, the terminal MD5 now has information about nine possible services to which it might connect. This information will be stored in a database within the terminal. As indicated above, there may be some overlap of searching and so the information stored may be reduced from the total information received.

However, in the example of FIG. 3, there are portions of the spectrum which have not been searched by any of the terminals or for which information has not been previously obtained. If the terminal MD5 is able to carry out further searches of the available spectrum, for example because it is not currently carrying out a fully supported communication with one service or is not using any service currently, then it may be able to carry out a search of additional portions of the spectrum.

The terminal MD5 can select a portion of the unsearched spectrum to search. Terminal MD5 uses its knowledge of the spectrum searched to identify the unsearched portions of the spectrum. It can then determine which parts and how much of the unsearched spectrum to search. This will be decided based upon a number of factors such as the available resources in the terminal, the number of other terminals which may be able to conduct searches, the need for the terminal to identify new services, battery life, etc.

In the example shown in FIG. 3, the terminal searches the portion of the spectrum labelled MD5-2 and by doing so locates a further available service S1. Having. completed its search of this portion of the spectrum, the information can be passed on to other terminals in the local network i.e. MD1 to MD4. The other terminals can then update their information of the searched spectrum. In this way, other terminals are able to conduct searches of other portions of the spectrum which have not yet been searched to try to complete the picture of the entire available spectrum.

In the example indicated above, the terminals transfer information about the results of the searches which they have carried out to other terminals in the local network. In this way, the set of terminals can cooperate to maintain a shared database of information on which portions of the service spectrum have been searched and where available services have been located. Furthermore, even where a terminal has carried out a search which has not yielded any services, this information is still useful as it avoids the need for other terminals to then conduct a search of the same area. For example, in FIG. 3, the terminal MD1, having acquired information on the searches carried out by the other terminals, carries out a further search in the portion of the spectrum which was previously unsearched. This is shown FIG. 3 as MD1-2. As can be seen from FIG. 3, there are no services available in this portion of the spectrum. Therefore, whilst the search is fruitless in terms of locating additional services, the information can still be used to update the database shared between the terminals so that when another terminal determines that it has the capacity to carry out a search of a further portion of spectrum, it need not search the same part of the spectrum again and so avoids unnecessary repetition of searching effort.

By spreading the information located by each terminal to neighbour terminals, each terminal can build up a database of scanned portions of the spectrum. Although it is preferable for a terminal to maintain its own database, limited resources may prevent this and some terminals may only store a limited subset of the information available or may rely totally upon information from other devices.

As indicated above, searches which yield no services still provide valuable information about the spectrum. Similarly, searches which overlap with previously searched portions of the spectrum can still provide useful information. As indicated above, they may relate to different technologies but they may also be more up to date and so effectively supersede the information on the overlapping portion.

When a search is carried out, the results of the search will identify the spectrum searched and the services located but the information can also include timing information about when the search was carried out and also the location of the terminal. Time information is important for maintaining the database to ensure that the information is current. In a dynamic network, the environment can vary considerably as terminals move around and also as other objects affect the availability of services. Similarly, a terminal which is moving has little use for information relating to a location which it is no longer in or was never in. The broadcast spectrum information may not just be passed to immediate neighbours but also on to their neighbours and so on. Consequently, a terminal may receive information which relates to the spectrum in a location which is distant from it and thus is not relevant. Only by knowing the location where the information is gathered and comparing that to its own location can the terminal determine the value of the information.

In order to maintain the information collectively held by a group of terminals, each terminal periodically broadcasts the data it currently holds (usually with a unique identifier) to be received by other terminals within range. These devices can then use the received information to update their own database or simply discard it if it does not meet their own criteria. For example, if a terminal is not able to communicate using a certain frequency band or technology, then it can ignore information relating to such services.

If each terminal transmits its entire database on a regular basis then the traffic on the local link may be significant. To reduce the amount of traffic, the delay between retransmissions can be reduced or only part of the information in the database may be transmitted, such as that received most recently or that which relates to a limited range of the terminal etc.

In this way, the collective information held by the terminals is disseminated to other terminals. However, it is also necessary to refresh the information periodically by searching previously searched portions of the spectrum again. The stored information may be reviewed periodically to determine if stored data is still valid. As suggested above, data may be deemed to be no longer valid for several reasons such as the location where the data was received is distant to the current location or the time when the data was received was too long ago. Failure to successfully connect to an indicated service may deem the data to be invalid and so on.

Periodically, each terminal may determine to carry out a search of the spectrum. This may be triggered by any number of factors. These may include the appearance of a new terminal (needing spectrum information), some or all of the data being deemed to be invalid, information on a portion of the spectrum in the database exceeding a certain age, the terminal having moved a predetermined distance from the location where it previously was or from where the information in its database was collected.

A further search may also be triggered by a desire for a new service as a result of some application operating on the terminal. A user may previously have been conducting an internet session but now wishes to stream a video signal and so needs greater bandwidth than it currently has information on. It therefore may carry out a search for a new higher bandwidth service. A search may also be initiated simply because the terminal has the capacity to carry out the search.

By way of example, a typical terminal might collect spectrum information over a period of time. After an amount of time, a portion of the information it holds becomes too old and so a new search of that portion is carried out. Subsequently, the terminal moves to a new location and a portion of the spectrum information, which relates to a previous location which is deemed to be too distant, is discarded and that portion of the spectrum is searched again. Finally, the user ends a high bandwidth video streaming session and wants to switch to a voice only call. This service might be provided by a cheaper service than the current connection. However, the database does not include information for that kind of service and so initiates a new search.

When a terminal determines that a new search is required, it must decide what portion of the spectrum to search. The terminal initially determines which portions of the spectrum it does not have valid information on. It may request information from other terminals to update its database before or after doing this. It must then determine which part and how much of the unsearched spectrum to search. This may be based upon current power levels (battery life) and efficiency of scanning. This could be based upon the relative capabilities of the terminals which are cooperating with each other. Some terminals may be able to take on a larger searching burden. For example, a terminal which is idle may be able to take on a larger share of the spectrum to search. Similarly, terminals which have lower power restrictions, i.e. are less sensitive to battery life, may take on a bigger share of the searching. A terminal which is powered by an external power source, for example in a car, would be not restricted by battery limitations whereas a battery powered terminal clearly has a limited power reserve. In this example, the powered device might take on a substantially greater part of the spectrum to search.

The number of terminals can be used to estimate how much of the spectrum to search. A terminal can monitor the number of device IDs included in recent broadcasts to estimate the number of local devices. The unsearched spectrum can them be divided proportionately between them.

It is clearly better if terminals do not search the same part of the spectrum and so a terminal may broadcast the part of the spectrum it is about to search or even seek confirmation before beginning a search of a particular portion. Alternatively, a random portion of the spectrum could be searched. Whilst this will inherently result in repetition, it should ensure that a significant part of the overall spectrum does get searched without the need for pre-agreement between the terminals. This avoids extra communication over the secondary network.

Once the portion of the spectrum is scanned, the terminal will update its database and broadcast the information either immediately, or with the terminal's next transmission.

Clearly, maintaining a shared database of information about the network service spectrum ensures that all terminals have a good knowledge of the service spectrum. However, distributing this information and maintaining the database at each terminal can put a significant burden on the terminals. This may need the terminals to have additional processing power and hence additional complexity. This can lead to the terminal being more expensive, larger, or more difficult to build. The additional processing may also mean an increased power usage and hence shorter battery life as well as possibly restricting the availability of the terminal to provide other functionality.

Additionally, the amount of information being transferred between the terminals may result in a significant amount of traffic on the local/secondary network. This may be undesirable as this may inhibit the capability of the local network to carry other desired information. This arrangement can also be a problem when the terminals are mobile. In order for the database information to be disseminated between the terminals reliably, it is necessary for some proportion of the terminals to remain in the area for long enough to establish a constant memory of the available services.

As an alternative to distributing detailed information about the portions of the spectrum searched by each terminal to its neighbours, the amount of information can be reduced by limiting the information transmitted. For example, the terminal may conduct its search but only provide information about services which it locates rather than full details of the total spectrum which it has searched. By only transmitting information about the services which are located, less information needs to be transmitted. In addition, where a search reveals no useful services, no information needs to be transmitted. Similarly where the same service is located by two terminals, it may not be necessary for the second terminal to find a service to transmit that information to other terminals.

Even with this reduced information, a new terminal joining the network would still be provided with information about a number of potential services which it could use. It can still search portions of the spectrum in between the services which it has received information on. This will still improve the chances of locating new services without repletion. It can be assumed that if a service has been located then the spectrum around that will have been searched. Thus starting a search in a portion of the spectrum away from the existing known services should be more productive than a random search.

FIG. 4 shows an example where the terminal MD5 joins a network and obtains information about discovered services from the other terminals in the local network. These known discovered services are shown in the upper part of the spectrum shown in FIG. 4, labelled DS. Terminal MD5 can still randomly determine to search a portion of the spectrum between the known services to determine if other services are available. In the example shown in FIG. 4, the search of the portion of the spectrum labelled MD5 would discover a further service.

The present invention primarily relates to the identification of available services for distribution to neighbouring terminals. Many protocols exist for the advertisement and discovery of services and these protocols could be used in an embodiment for the distribution of network service information. In one implementation, the network service information could be presented in a descriptive mark-up language such as XML (Extensible Markup Language) within the Resource Description Framework (RDF). The use of such descriptive languages enables the network service information to have a very rich content , imparting significantly more information than could be derived from simply scanning the radio spectrum.

FIG. 5 is a diagrammatic representation of the network service information expressed in such a format. As can be seen from FIG. 5, the network service information is broadly sub-categorised into “network information” and “service information”. The former is sub-categorised into “general”, “quantitative” and “qualitative” information and the latter is sub-categorised into different services. Examples of information in the “general network” sub-category are the network name, operator name, network technology, access status, donor location, validity period, basestation/access point identifier, modulation scheme and spreading code. Information within the “quantitative network” sub-category can include the received signal strength indicator (RSSI), transport channel block error rate, signal-to-noise ratio (SNR), transmit power, operating frequency range, carrier frequency, channel bandwidth, bit error rate (BER) and latency. Information in the “qualitative network” sub-category includes the network loading rating and the quality-of-service (QoS) rating. Within each service sub-category, information can include the name of the service, the type of the service (for example, MMS or A/V streaming) and the cost associated with the service.

The secondary communications channel described above can be, for example, a Bluetooth™ channel or any other type of wireless channel, for example an infrared or WiFi channel. The advantage of using a secondary communications channel different to the primary communications channel used for communications over the primary network is that network service information can be transmitted without affecting access to the network and services provided over the primary communications channel. However, it is also possible that the primary communications channel is used to transmit and receive network service information; the time taken for this purpose would not be as great as a conventional spectrum-scanning approach.

One of the main issues concerning the choice of technology for the secondary communications channel is coverage. In an ad hoc network, devices are connected if they are directly within range of another device. In one embodiment of the present invention, devices will pass on network service information by broadcasting it to any other device within communication range, who will in turn pass it on to others. Thus a device can receive network service information if there is a path between it and the device that originally obtains the information. Such a device is then within coverage of the originating device. Simulations can estimate coverage for secondary communication channel technologies with different transmission ranges.

Although an embodiment of the present invention has been described in relation to mobile devices, it will be appreciated that fixed communication devices can also form part of the communications system over which the collaborative discovery method operates. Any type of fixed or mobile communication device can be used with the present invention.

The present invention avoids the need for scanning of large portions of the spectrum and is therefore less time consuming than conventional methods. Directly related to the amount of time that spectrum scanning techniques take to complete is the amount of power such procedures would consume. It is important that power consumption is minimised since mobile devices are reliant on limited power supplies. An embodiment of the present invention is far more power efficient than conventional discovery techniques. The present invention can also utilise low-power, short-range radio links to transmit network service information to achieve a more power-efficient distribution. The present invention enables a re-configuration procedure to be completed in a very short time compared to conventional procedures in which a lengthy discovery process must first be completed.

No doubt many other effective alternatives will occur to the skilled person. It will be understood that the invention is not limited to the described embodiments and encompasses modifications apparent to those skilled in the art lying within the spirit and scope of the claims appended hereto.

1. A collaborative discovery method for discovering available network services at a communication terminal, the method comprising:
receiving network service spectrum information;
updating stored network service spectrum information using said received network service spectrum information;
selecting a portion of the network service spectrum to be searched based upon the stored network service spectrum information; and
searching said selected portion of the network service spectrum.

2. A collaborative discovery method according to claim 1 further comprising:
updating said stored network service spectrum information using said network service spectrum information located during said searching.

3. A collaborative discovery method according to claim 1 further comprising:
broadcasting discovered information, wherein said discovered information is based upon the network service information located during said searching.

4. A collaborative discovery method according to claim 3 wherein the discovered information includes information identifying network services located within the selected network service spectrum.

5. A collaborative discovery method according to claim 3 wherein the discovered information includes details of the selected portion of the network service spectrum which was searched.

6. A collaborative discovery method according to claim 3 wherein said broadcasting includes sending a unique terminal identifier.

7. A collaborative discovery method according to claim 3 wherein said stored network service spectrum information is broadcast over a second network and said network service spectrum information relates to one or more first networks.

8. A collaborative discovery method according to claim 1 wherein said stored network service spectrum information is broadcast in response to a request received from another terminal.

9. A collaborative discovery method according to claim 1 wherein said selected portion of the network service spectrum to be searched is selected from the portions of the stored network service spectrum on which no valid information is stored.

10. A collaborative discovery method according to claim 1 further comprising updating the stored network service spectrum information by determining if each part of said stored network service spectrum information is valid, wherein said stored network service spectrum information is determined not to be valid if it is one or more of:
older than a predetermined age; and
collected at a location more than a predetermined distance from the current location of the terminal.

11. A collaborative discovery method according to claim 1 wherein the portion of the network service spectrum to be searched is randomly selected.

12. A collaborative discovery method according to claim 1 wherein the size of the selected portion of the network service spectrum is determined based upon one or more of the following:
the number of neighbouring terminals;
the capability of the terminal to carry out searching, relative to neighbouring terminals;
capacity of the secondary network over which the network service spectrum information is broadcast and/or received; and
the terminal's remaining power reserve.

13. A collaborative discovery method according to claim 12 wherein the number of neighbouring terminals is determined by identifying each unique terminal which broadcast information has been received from based upon a unique terminal identification broadcast by said terminals.

14. A collaborative discovery method according to claim 1 wherein said searching is repeated if one or more of the following have occurred:
some or all of the stored network service spectrum information is older than a predetermined age;
some or all of the stored network service spectrum information was collected at a location more than a predetermined distance from the current location of the terminal; and
the terminal requires a network service which is not included in the stored network service spectrum information.

15. A collaborative discovery method for discovering available network services, the method comprising:
searching a randomly selected portion of the network service spectrum and storing discovered network service spectrum information;
broadcasting information concerning the network service spectrum searched;
receiving network service spectrum information; and
updating stored network service spectrum information using said received network service spectrum information.

16. A collaborative discovery method for discovering network services at a plurality of communication terminals, the method comprising:
each terminal receiving network service spectrum information from one or more of the other of said plurality of terminals;
maintaining stored network service spectrum information at one or more of said plurality of terminals and updating said network service spectrum information based upon said received network service spectrum information;
one or more of said plurality of terminals periodically selecting a portion of the network service spectrum to be searched based upon the stored network service spectrum information and searching said selected portion of the network service spectrum; and
each terminal periodically broadcasting said stored network service spectrum information.

17. A communication terminal for discovering available network services, the terminal comprising:
a receiver arranged to receive network service spectrum information;
network service spectrum information storage;
a storage manager arranged to store network service spectrum information in said storage and to update said network service spectrum information using said received network service spectrum information;
a selector arranged to determine a portion of the network service spectrum to be searched based upon the stored network service spectrum information; and
a spectrum scanner for searching said portion of the network service spectrum.

18. A communication terminal according to claim 17 wherein said storage manager updates said stored network service spectrum information using said network service spectrum information located by said spectrum scanner.

19. A communication terminal according to claim 17 further comprising:
a transmitter arranged to broadcast said network service spectrum information discovered by said spectrum scanner, wherein said discovered information is based upon the network service information located during said searching.

20. A communication terminal according to claim 19 wherein the transmitter broadcasts discovered information which includes information identifying network services located within the selected network service spectrum.

21. A communication terminal according to claim 19 wherein the transmitter broadcasts discovered information which identifies the selected portion of the network service spectrum which was searched.

22. A communication terminal according to claim 19 wherein the transmitter broadcasts a unique terminal identifier.

23. A communication terminal according to claim 19 wherein the transmitter broadcasts said network service spectrum information over a second network and said network service spectrum information relates to one or more first networks.

24. A communication terminal according to claim 17 wherein the transmitter broadcasts said stored network service spectrum information in response to a request received from another terminal.

25. A communication terminal according to claim 17 wherein said selector selects said portion of the network service spectrum to be searched based upon the portions of the network service spectrum on which no valid information is stored in said storage.

26. A communication terminal according to claim 17 wherein said storage manager is arranged to update the stored network service spectrum information by determining if a part of said stored network service spectrum information is valid, wherein said stored network service spectrum information is determined not to be valid if it is one or more of:
older than a predetermined age; and
collected at a location more than a predetermined distance from the current location of the terminal.

27. A communication terminal according to claim 17 wherein the selector randomly selects said portion of the network service spectrum to be searched.

28. A communication terminal according to claim 17 wherein the selector is arranged to determine the size of the selected portion of the network service spectrum based upon one or more of the following:
the number of neighbouring terminals;
the capability of the terminal to carry out searching, relative to neighbouring terminals;
the capacity of a secondary network over which the network service spectrum information is broadcast and/or received; and
the terminal's remaining power reserve.

29. A communication terminal according to claim 28 wherein the receiver is arranged to identify each unique terminal which broadcast information is received from based upon a unique terminal identifier broadcast by each terminal in order to determine the number of unique neighbouring terminals.

30. A communication terminal according to claim 17 wherein said storage manager controls the selector and spectrum scanner to carry out a further search when it determines that one or more of the following have occurred:
some or all of the stored network service spectrum information is older than a predetermined age;
some or all of the stored network service spectrum information was collected at a location more than a predetermined distance from the current location of the terminal; and
the terminal requires a network service which is not included in the stored network service spectrum information.

31. Processor control code to, when running, implement the method of claim 1.

32. A carrier medium carrying processor control code , when running, implement the method of claim 1.
